(19) United States
(12) Patent Application Publication
(10) Pub. No.: US 2021/0056269 A1
(43) Pub. Date: Feb. 25, 2021

(54) Persian Expressions Translated Into Emojis

(71) Applicant: Shahrzad Shabatian, Beverly Hills, CA (US)

(72) Inventor: Shahrzad Shabatian, Beverly Hills, CA (US)

(21) Appl. No.: 17/093,443

(22) Filed: Nov. 9, 2020

(51) Int. Cl. G06F 40/53; G06F 40/129; H04L 12/58

(52) U.S. Cl. CPC G06F 40/53; G06F 16/51; H04L 51/10; G06F 40/129

(57) ABSTRACT

A database of Persian words and Persian phrases are mapped to Persian emojis or graphic Persian representations of the mapped phrase or word. A separate database may comprise a plurality of Persian emojis or Persian graphic representations. A lookup database or listing may map or correlate each Persian phrase or Persian word to one or more Persian emojis. The one or more mapped Persian emojis may be presented to an end user who may select one or more Persian emojis for insertion into an electronic message.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

### Field of the Invention

The invention generally relates to emoji generation. More particularly, the invention relates to means and methods of creating and depositing an emoji in response to a phrase, such as a Persian phrase typed in a message.

### Description of the Related Art

The known related art fails to anticipate or disclose the principles of the present invention.

In the related art, general emojis are known and may be selected from drop down lists or groups of emojis presented in general displays. The known prior art is devoid of systems or means of presenting an emoji in response to a user typing out a Persian phrase or Persian word. As many Persian phrases are unique and not widely known in the English language, end users have not been able to take advantage of the richness of Persian phrases or the Persian language. Thus, there is a need in the art for the presently disclosed embodiments.

### BRIEF SUMMARY OF THE INVENTION

The present invention overcomes shortfalls in the related art by presenting an unobvious and unique combination and configuration of methods and components to present emojis in reaction to a Persian phrase or a Persian word typed or selected for an electronic communication.

The invention overcomes shortfalls in the related art by using a database of Persian words and Persian phrases that are mapped to Persian emojis or graphic Persian representations of the mapped phrase or word. A separate database may comprise a plurality of Persian emojis or Persian graphic representations. A lookup database or listing may map or correlate each Persian phrase or Persian word to one or more Persian emojis. The one or more mapped Persian emojis may be presented to an end user who may select one or more Persian emojis for insertion into an electronic message.

The invention overcomes shortfalls in the art by presenting means and methods for a recipient of a Persian emoji to have the meaning of the Persian emoji displayed. Thus, users who are not fluent in Persian will obtain an understanding or Persian emojis sent to them.

By similar means and methods, a non-Persian speaker may view a listing of Persian phrases and send a selected Persian phrase with or without a related Persian emoji.

These and other objects and advantages will be made apparent when considering the following detailed specification when taken in conjunction with the drawings.

### BRIEF DESCRIPTION OF THE DRAWINGS

FIG. 1 depicts a sample Persian emoji or Persian graphic

FIG. 2 depicts a sample Persian emoji or Persian graphic

FIG. 3 depicts a sample Persian emoji or Persian graphic

FIG. 4 depicts a sample Persian emoji or Persian graphic

FIG. 5 depicts a sample Persian emoji or Persian graphic

An Appendix to the Specification is filed with this Specification and includes sample phrases in Persian translated to English. The sample phrases are not inclusive of all phrases contemplated by the disclosed embodiments.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

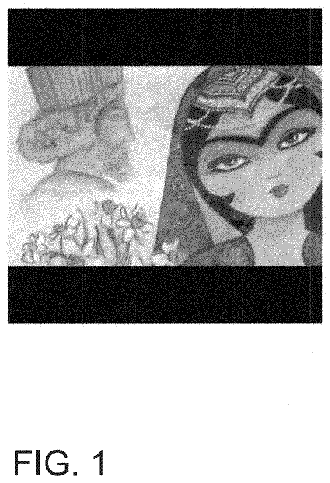

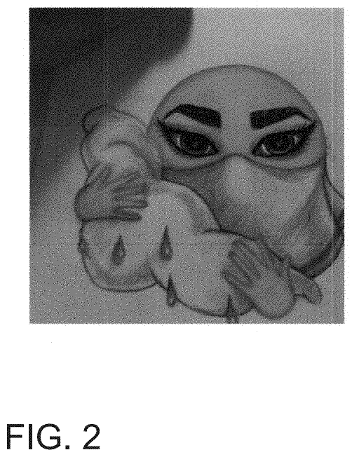

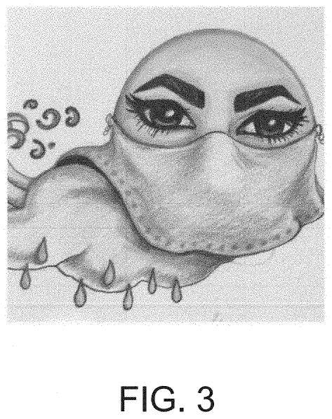

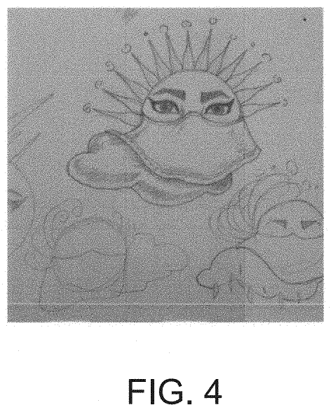

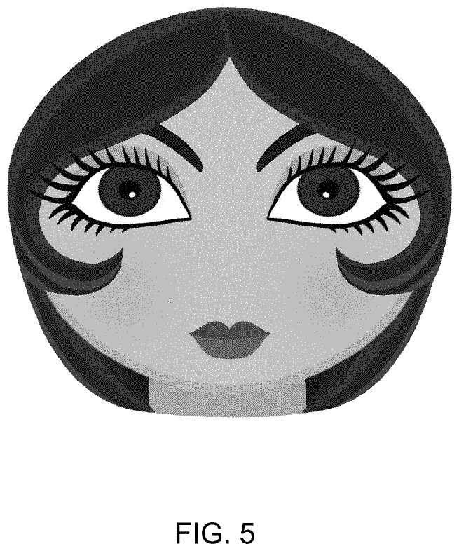

FIGS. 1 to 5 depict sample Persian emojis or icons. The disclosed embodiments include all possible emojis and icons with related phrases or words, with such related phrases and words translated from English to Persian and from Persian to English.

The disclosed embodiments include a plurality of databases, mapping tables and executable computer programs. The disclosed embodiments include apps or smart phone software programs or applications that may reside within a smart phone or be cloud based.

In one contemplated system, a phone app may be downloaded with the download containing a plurality of Persian phrases mapped to Persian emojis. Cloud based updates may be pushed to application users. Crowd based updates may be facilitated wherein users add their own phrases and emojis to the cloud-based databases.

Disclosed embodiments include the use of artificial intelligence or the machine recognition of end user patterns of use. Thus, a user may type in or select a Persian phrase and then be presented with a plurality of Persian emojis fitting to the selected phrase. A user may select one or more emojis to be added to the phrase. Over time, the system will present the most selected emojis.

In another disclosed embodiment, a user may be texting in English and may be presented with Persian phrases that have the same approximate meaning. The user will have the option of adding the presented Persian phrase and/or presented Persian emoji.

In another disclosed embodiment, a user may be texting in Persian and may text a phrase that is close to or the same as a stored Persian phrase. In response, one or more appropriate Persian emojis may be presented for the user to select.

A disclosed “system” may include a processor that reads instructions on nonvolatile media in communication with a network, such as the Internet. A system may include a plurality of databases, such as a database of Persian words and Persian phrases, a database of emojis or graphics. A system may also include on or more look up tables or other means to map a selected Persian word or phrase to one or more emojis. A plurality of emojis may be presented to an end user, with the end user selecting one or more emojis for display and/or transmission to a recipient.

The database of Persian words and Persian phrases may include pointers to preselected emojis, and thus not necessarily use a look up table.

In one contemplated embodiment, a user may type in or otherwise input a Persian word or Persian phrase in an email or text. The system would then present an emoji in response to the user's input. The presented emoji might be a play upon or humorous version of the inputted word or phrase.

Disclosed embodiments may include the following items.

Item 1. A method of generating an emoji in response to the input of a Persian word or Persian phrase, the method comprising the steps of:

a system accepting input of a Persian word or Persian phrase;

the inputted Persian word or Persian phrase being mapped to an emoji, the emoji stored in a database of emojis; and

displaying the emoji mapped to the inputted Persian word or Persian phrase.

Item 2. The method of item 1 further comprising the step of:

the inputted Persian word or Persian phrase being inputted into an electronic message.

Item 3. The method of item 2 further comprising the step of:

displaying the mapped emoji after the inputted Persian word or Persian phrase.

Item 4. The method of item 3 further including the step of using a mapping table used to correlate the inputted Persian word or Persian phrase to the emoji.

Item 5. The method of item 4 further including the step of using a database of Persian words and Persian phrases that is compared to the inputted Persian word or Persian phrase, when a match in the database of Persian words and Persian phrases is found the mapping table is used with the database of emojis to find the emoji to display.

Item 6. The method of item 5 wherein the mapping table directs multiple emojis to be displayed in a drop-down menu, the multiple emojis stored in the database of emojis.

Item 7. The method of item 6 wherein the system comprises a server in communication with a network and the network in communication with an end user, the end user inputting the Persian word or Persian phrase being mapped to an emoji.

What is claimed is:

1. A method of generating an emoji in response to the input of a Persian word or Persian phrase, the method comprising the steps of:
a) a system accepting input of a Persian word or Persian phrase;
b) the inputted Persian word or Persian phrase being mapped to an emoji, the emoji stored in a database of emojis; and
c) displaying the emoji mapped to the inputted Persian word or Persian phrase.

2. The method of claim 1 further comprising the step of:
the inputted Persian word or Persian phrase being inputted into an electronic message.

3. The method of claim 2 further comprising the step of:
displaying the mapped emoji after the inputted Persian word or Persian phrase.

4. The method of claim 3 further including the step of using a mapping table used to correlate the inputted Persian word or Persian phrase to the emoji.

5. The method of claim 4 further including the step of using a database of Persian words and Persian phrases that is compared to the inputted Persian word or Persian phrase, when a match in the database of Persian words and Persian phrases is found the mapping table is used with the database of emojis to find the emoji to display.

6. The method of claim 5 wherein the mapping table directs multiple emojis to be displayed in a drop-down menu, the multiple emojis stored in the database of emojis.

7. The method of claim 6 wherein the system comprises a server in communication with a network and the network in communication with an end user, the end user inputting the Persian word or Persian phrase being mapped to an emoji.
